(19) United States
(12) Patent Application Publication
(10) Pub. No.: US 2002/0011018 A1
(43) Pub. Date: Jan. 31, 2002

(54) Air-texturized dubbing yarn and method of tying a fishing fly using same

(76) Inventor: Francis J. Healy, Douglasville, PA (US)

Correspondence Address: Steven D. Kerr, Womble Carlyle Sandridge & Rice, P.O. Box 725388, Atlanta, GA, 31139-9388, US

(21) Appl. No.: 09/906,259

(22) Filed: Jul. 16, 2001

Related U.S. Application Data
(60) Provisional application No. 60/218,718, filed on Jul. 17, 2000.

(51) Int. Cl. A01K 85/00

(52) U.S. Cl. 43/42.24

(57) ABSTRACT

An air-texturized dubbing yarn is provided for use in tying the body portion of a fly fishing fly. The dubbing yarn is formed in an air texturizing machine and includes a core thread and one or more effect threads that are air-entangled through and frayed about the core thread to present a fuzzy texture. The colors of the threads are selected to form a combined color scheme that mimics the natural colors of live flies. A method of tying a fly includes attaching one end of a length of air-texturized yarn to the shank of a hook and wrapping the yarn about the shank to form a fly body mimicking that of a live fly. Hackle and other materials may then be added to complete the fly.

### REFERENCE TO RELATED APPLICATION

The benefit of the filing date of U.S. provisional patent application No. 60/218,718 filed on Jul. 17, 2000 is hereby claimed.

### TECHNICAL FIELD

The invention disclosed in this provisional patent application relates generally to fishing tackle and more specifically to artificial flies for use in fly fishing.

### BACKGROUND

Fly fishing is a popular sport among fishermen and is considered by many to be particularly challenging and to require exceptional fishing skill and patience. Many people who enjoy fly fishing eventually begin to tie their own fishing flies for use as artificial lures. Motivations for this include the perception that tying one's own flies is less expensive than purchasing commercially tied flies and, more importantly, the challenge and satisfaction in creating fly designs that are unique and that actually catch fish. Generally, artificial flies are designed to mimic the various growth stages of a variety of insects that are appealing to the types of fish being sought. Such flies range from simple standards such as the Woolly Worm and Black Nose Dace to complex and creative facsimiles of a variety of larva, nymphs, pupa, adult flies, and other insects that are thought to attract specific species of fish. In this regard, the terms “fly” and “flies” are used herein to encompass not only flies but also any other insect such as, for example, a beatle, and all of the forms that a fly or insect may take in its growth cycle, any of which may be simulated in an artificially tied lure

The basic process of tying a fly includes attaching a variety of natural and synthetic materials such as wool, animal hair, hackle or feathers, tinsel, and other materials that mimic anatomical structures of live flies to a fish hook. These materials typically are attached to the hook by wrapping various treads around the hook and around portions of the materials to fix them to the hook. The goal is to select materials having colors, textures, and appearances that, when combined, appear to a fish to be a tempting meal when cast on or in the water.

While the nuances of fly tying are beyond the scope of this disclosure, FIGS. 1 through 14 attached hereto illustrate, as background, the basic steps involved in the traditional and prior art process of tying flies. First, a hook is mounted in a vice (FIG. 1) and dubbing (FIG. 2) is selected for what is to be the body of the fly. Traditionally, dubbing may be any of a wide variety of materials including animal hair, synthetic fibers, or other types of material having a “fuzzy” texture. The mixture of colors included in the dubbing is important since the goal is to create a fly with a color scheme that appears to fish to be natural. Typical colors for dubbing may be mixtures of greens, browns, blacks, and whites, although a wide variety of dubbing colors and mixtures are used. A wide selection of natural animal hairs and synthetic fibers are available for creating an equally wide variety of color schemes. Selecting the proper dubbing to produce an effective finished color scheme is considered by many to be part of the art and skill of fly tying.

With the dubbing selected, one or more wrapping threads are initially attached or wrapped onto the hook (FIGS. 3 and 4). A length of the loose dubbing may then be applied to the hanging wrapping threads (FIG. 5) and the combination is twisted between the fingers to create a “fuzzy” length of dubbing attached at one end to the hook (FIG. 6). The fuzzy length of dubbing is then wrapped around the hook to cover its shank and may be secured by a few turns of a wrapping thread applied from a bobbin attached to a spool (FIG. 7). The result is a simulation of the fuzzy or hair born body and/or thorax of a natural nymph or pupa.

Once the body of the fly is dubbed, a variety of natural and/or synthetic materials such as, for example, cellophane to simulate wings (FIGS. 8 and 9), hackle or feathers to simulate body projections (FIGS. 10 and 11), dubbing to simulate a head (FIG. 12), and additional hackle to simulate antenna (FIG. 13) may be attached with wrapping thread or otherwise to create the finished fly (FIG. 14), which, it is hoped, will appeal to fish.

One of the problems with traditional fly tying lies in the time consuming and material intensive process of dubbing the body of the fly. Effective dubbing also requires experience and substantial skill in selecting the color combinations of the natural and/or synthetic dubbing materials and in applying the proper amount of dubbing in the proper way to obtain a convincing result. Many fly tiers, especially novice tiers, find the proper selection and application of dubbing to be a difficult challenge. Further, the time required for the dubbing process can be frustrating even for experienced tiers, especially when flies are tied in the field where speed is an important factor.

Thus, a need exists for a method of tying a fly wherein the dubbing may be applied quickly, easily, and with a minimum of required skill and experience in selecting the proper dubbing materials. It is to the provision of such a fly tying method and to a pre-fabricated dubbing material for use therein that the present invention is primarily directed.

### SUMMARY OF THE INVENTION

Briefly described, the present invention, in a preferred embodiment thereof, comprises a method of tying a fishing fly and is specifically related to the portion of the process known as dubbing. As mentioned above, dubbing refers to the tying of a “fuzzy” material about the shank of a fish hook to create the illusion that the shank is the body of a fly. The method involves the use of a specially treaded combination thread product known as air-texturized yarn. Air texturizing is a process of treating threads wherein one or more, and preferably two or more, threads are passed through the head of an air texturizing machine. Within the head of the machine, the threads are air-entangled and one or more of the threads is intentionally frayed by specialized applications of compressed air to produce a roughened or texturized surface on the resulting composite thread. Air texturizing of threads is used, for example, to impart a slightly roughened surface to dental floss and to produce certain yarns used in the textile industry.

For the present invention, a core thread of a pre-selected color and one or more effect threads of other pre-selected colors are passed through an air texturizing machine equipped with a head designed to air-entangle the threads and to produce extreme fraying of the effect threads. The colors of the core thread and effect threads are carefully selected such that the composite takes on the color and appearance of natural materials, such as animal hair, traditionally used for dubbing. The result is a frayed or fuzzy air-texturized dubbing yarn having a color scheme that mimics the natural colors of the body of a live fly.

The method of the invention comprises attaching one end of a length of air-texturized dubbing yarn to the shank of a fish hook. The dubbing yarn is then wrapped around the shank of the hook to a desired density, tied off, and trimmed. The result is a convincing facsimile of the body of a live fly with the frayed portion of the dubbing yarn providing a fuzzy look that is substantially the same as that obtained through traditional dubbing techniques using selected animal hair or synthetic material. Once the dubbing of the body of the fly with dubbing yarn according to the invention is complete, hackle and other materials may be attached to the hook in the traditional way to complete the fly.

Thus, application of the air-texturized dubbing yarn according to the method of this invention produces a high quality fishing fly that is equally as convincing as a fly with a traditionally dubbed body. However, the tedious and sensitive selection of various colors and textures of dubbing material and the intricate process of winding or twisting the material into a thread and wrapping the combination around the shank of the hook are all eliminated. This is because the colors and textures of the core and effect threads used to create the air-texturized dubbing yarn are pre-selected to provide a variety of proven color combinations appropriate for a wide range of fish. Preferably, the colors are selected to comply with standardized fly tying color schemes such as those of the Gary Borger Color System, but this is not a requirement or limitation of the invention. A novice fly tier is thus able to apply professional looking dubbing quickly and easily using the dubbing yarn of the invention. Further, the speed and ease with which the dubbing yarn is applied make the process uniquely suited for tying flies in the field, whether by the novice or professional.

The invention also contemplates an air-texturized dubbing yarn for use in the fly tying method of the invention. Additional features, objects, and advantages of the invention will become more apparent upon review of the detailed description set forth below when taken in conjunction with the accompanying drawing figures, which are briefly described as follows.

### BRIEF DESCRIPTION OF THE DRAWINGS

FIGS. 1 through 14 illustrate generally the traditional steps involved in fly tying, including the traditional method of dubbing the body of the fly.

FIG. 15 illustrates a length of air-texturized dubbing yarn according to the present invention.

FIG. 16 illustrates initial steps of a method of tying flies that embodies principles of the invention in a preferred form.

FIG. 17 illustrates a fish hook that has been dubbed according to the present invention to produce the body of a fly.

### DETAILED DESCRIPTION OF THE PREFERRED EMBODIMENTS

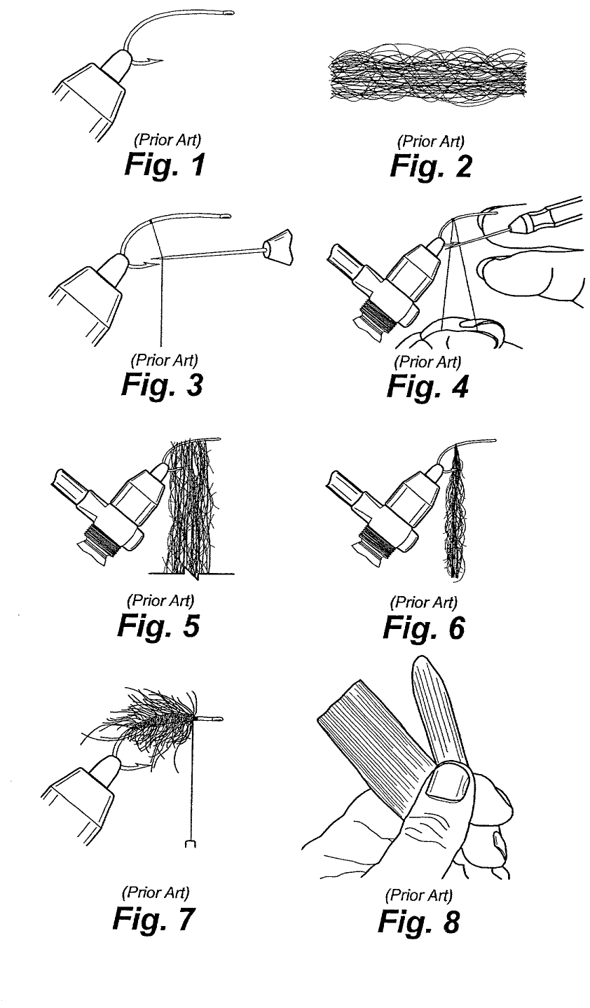

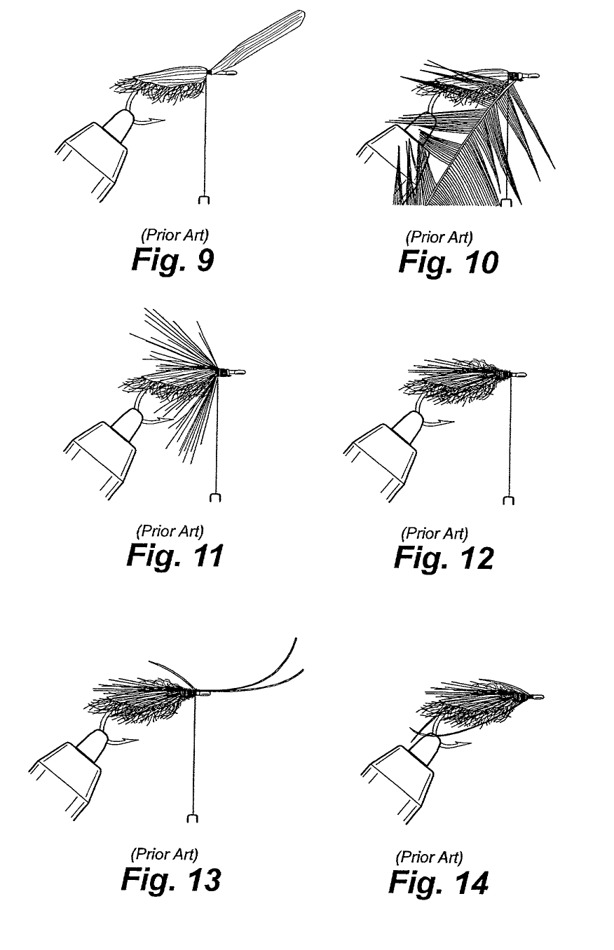

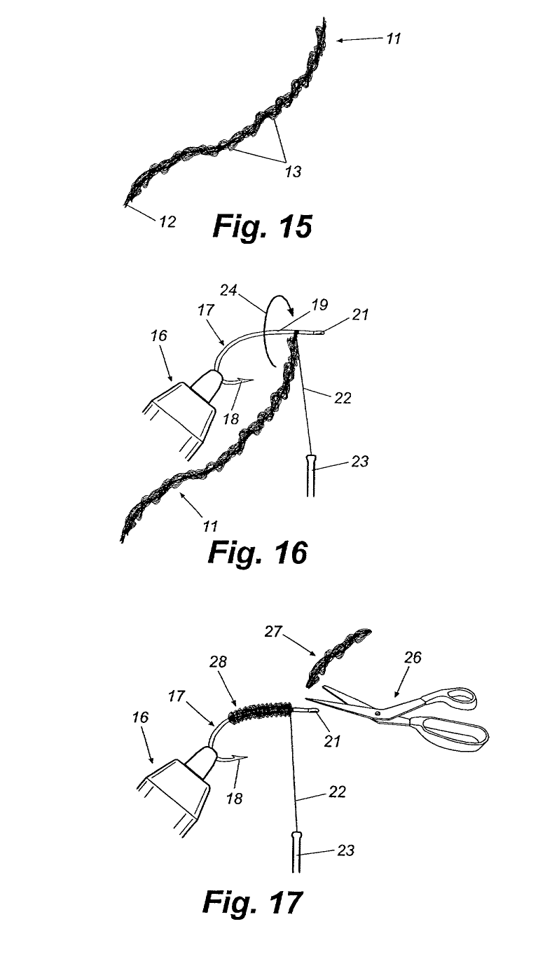

Referring now in more detail to FIGS. 15 through 17 (FIGS. 1 through 14 are discussed above), wherein like reference numerals refer to like parts throughout the several views, FIG. 15 illustrates a length of air-texturized dubbing yarn according to principles of the invention. The yarn 11 comprises a core thread 12 about and through which one or more effect threads 13 have been applied within the head of an air texturizing machine (not shown). Air texturizing machines suitable for creating the air-texturized dubbing yarn of this invention are commercially available and one preferred supplier of such machines is the STÄHLE Company of Germany. A variety of heads may be obtained for the air texturizing machine to achieve various finished effects. For the present invention, a head that produces a loose and highly frayed effect with the effect threads being air-entangled with the core thread is preferred, although other heads may be chosen to produce other effects if desired.

The air-texturized dubbing yarn 11 in FIG. 15 may be formed from a core thread and one, two, three, or more effect threads to produce a desired finished color and texture. The colors of the selected threads are chosen such that the air-texturized dubbing yarn has a finished color scheme that appears natural to mimic the body of a live fly. In this regard, it has been found that selecting and blending threads died according to the Gary Borger Color System, a color scheme specifically designed for fly tying, produces convincing yarn colors that generally are mottled or grizzly in color and that mimic well the color combinations obtained by an experienced fly tier using natural hairs and other materials.

In general, thread colors suitable for use in the dubbing yarn of this invention include browns, greens, blacks, and whites, although other colors certainly may be used. Further, in some cases a solid color may be desirable and in these cases the air-texturized dubbing yarn may be formed from multiple threads of the same color such as, for example, black or white. In addition, threads of different gauges or sizes may be subjected to the air texturizing process to provide finished dubbing yarns of different thickness for tying a variety of sizes and styles of flies.

FIG. 16 illustrates one embodiment of the initial steps of the method of the present invention using a length of air-texturized dubbing yarn 11 as previously described. A fish hook 17 of an appropriate size for the fly being tied is clamped in a fly tying vice 16. The hook 17 has a barb 18, a shank 19, and an eye 21. It should be noted that the hook also may be a barbless hook. Initially, the end of a length of fine fly tying thread 22 is fixed to the shank 19 at a selected location, which in the illustrated embodiment is adjacent the eye 21, but that may be at any location along the shank. Conventionally, the fly tying thread is paid out from a bobbin 23, which is attached to a spool of thread (not shown). The end of the fly tying thread may initially be attached to the shank 19 by wrapping it a few turns on itself and then allowing the bobbin and spool to hang downwardly from the attachment point.

An end of a length of dubbing yarn 11 according to the present invention is next fixed to the shank 19 of the hook. This may be done by positioning the end of the dubbing yarn at the location where the fly tying thread is attached and wrapping the fly tying thread around the end of the dubbing yarn a few times. Once the end of the dubbing yarn is securely fixed to the shank 19, the yarn 11 is wrapped systematically as indicated by arrow 24 around the shank 19 moving up and down the length thereof until the shank is covered with dubbing yarn. The spacing between successive windings of the yarn and the number of windings of the yarn may be adjusted to provide a thicker or thinner coat of dubbing yarn on the shaft of the hook to simulate the bodies of a variety of flies.

As best illustrated in FIG. 17, when the dubbing yarn 11 has been wrapped about and covers the shank 19 of the hook 17, the free end 27 of the yarn may be fixed to the shank with wrapping thread and the excess trimmed with an appropriate trimmer such as sharp-nosed scissors 26. The result is a covering 28 of the dubbing yarn on the shank of the hook that exhibits the same fuzzy texture and the same naturally appearing color scheme as traditional dubbing. However, as mentioned above, the critical selection of appropriate dubbing materials and color combinations is eliminated because these characteristics are built into the dubbing yarn and the time required to dub the fly with the dubbing yarn of this invention is significantly less than that required with conventional dubbing techniques. Once the body of the fly has been dubbed as described, the fly may be completed in the traditional way by tying appropriate hackle onto the fly and adding a head and other elements to mimic the look of a live fly. In the finished fly, the dubbing yarn around the shank of the hook forms the body of the fly while the hackle forms wings, antenna, and other appendages.

It has been found that one may combine dubbing yarns of different colors and textures according to the invention if desired to achieve a variety of looks depending on the type of fly being created. For example, it has been discovered that first winding a reflective red tinsel around the shank of a hook and covering the tinsel with white air-texturized dubbing yarn creates the effect of a hair covered fly body with an underlying vein, especially when the fly is wet. Such a combination has been found effective in attracting certain kinds of fish. These and many other variations, combinations, additions, deletions, and modifications to the preferred embodiments illustrated and described herein may well be made by those of skill in the art without departing from the spirit and scope of the invention as set forth in the claims.

What is claimed is:

1. A method of tying a fishing fly comprising the steps of:
(a) providing a hook having a shank;
(b) attaching one end of a length of air-texturized yarn to the shank of the hook; and
(c) wrapping the air-texturized yarn about the shank of the hook to cover the shank, the wound yarn mimicking the body of a fly.

2. A method of tying a fishing fly as claimed in claim 1 and wherein the air-texturized yarn has a core thread and an effect thread, the effect thread being entwined and frayed about the core thread.

3. A method of tying a fishing fly as claimed in claim 2 and wherein the core thread and the effect thread are of different colors.

4. A method of tying a fishing fly as claimed in claim 3 and wherein the colors of the treads are selected from a standardized color chart.

5. A method of tying a fishing fly as claimed in claim 4 and wherein the standardized color chart is taken from the Gary Borger Color System.

6. A method of tying a fishing fly as claimed in claim 4 and further comprising the steps of tying hackle onto the hook to mimic anatomical appendages of a live fly.

7. A method of tying a fishing fly as claimed in claim 1 and further comprising the step of wrapping the shank of the hook with tinsel prior to wrapping the shank with dubbing yarn.

8. A method of tying a fishing fly as claimed in claim 7 and wherein the tinsel is red to mimic a vein of the fly.

9. A method of tying a fishing fly as claimed in claim 8 and wherein the dubbing yarn is white.

10. A dubbing yarn for tying a fishing fly, said dubbing yarn having a core thread and an effect thread and being air-texturized such that said effect thread is frayed and entwined within said core thread to present a fuzzy texture, said core thread and said effect thread having pre-selected colors that combine to produce a dubbing yarn with a predetermined naturally appearing color scheme.

11. A dubbing thread as claimed in claim 10 and wherein said core thread and said effect thread are different colors.

12. A fishing fly comprising a hook having a shank and a fly body formed about said shank, said fly body being formed by air-texturized dubbing yarn wrapped about said shank.
